(19) United States
(12) Patent Application Publication
(10) Pub. No.: US 2014/0287736 A1
(43) Pub. Date: Sep. 25, 2014

(54) LIMITING FUNCTIONALITY OF A PORTABLE ELECTRONIC DEVICE BASED ON THE LOCATION OR SPEED THEREOF

(71) Applicant: David Meers, Suwanee, GA (US)

(72) Inventor: David Meers, Suwanee, GA (US)

(21) Appl. No.: 14/221,860

(22) Filed: Mar. 21, 2014

Related U.S. Application Data
(60) Provisional application No. 61/803,790, filed on Mar. 21, 2013.

(51) Int. Cl. H04M 1/725; H04W 4/02

(52) U.S. Cl. CPC H04M 1/72577; H04W 4/027
USPC 455/418

(57) ABSTRACT

Implementations of the present disclosure allow an administrator of a portable electronic device (e.g., a parent, employer) through a web application to register a portable electronic device and then set a minimum speed at which the portable device 100 becomes limited (for example, limiting calling and/or texting). In some implementations, the administrator also can set locations or geographical areas where and dates and times when the portable electronic device will be limited (“TextLimit Zones”). In some implementations, the administrator can set a maximum speed at which the administrator (or another designated recipient) will receive an alert message 105 when the portable electronic device exceeds that speed. In some implementations, the administrator can specify one or more telephone numbers (“Go Through Numbers”) that the portable electronic device can still communicate with when the portable electronic device is limited due to the setting established by the administrator.

### CROSS REFERENCE TO RELATED APPLICATION

This application claims the benefit of U.S. Patent Application Ser. No. 61/803,790, which was filed on Mar. 21, 2013, and is incorporated herein by reference in its entirety.

### TECHNICAL FIELD

This disclosure relates to limiting the functionality of a portable electronic device based on the location of the portable electronic device or the speed of a portable electronic device.

### BACKGROUND

In 2010, about 3,092 people were killed and an estimated 416,000 were injured in accidents involving distracted driving. Approximately 11% of drivers under 20 years of age have been the victim of fatal accidents due to distracted driving. The cell phone can cause distracted driving. In fact, at least one study reports that forty percent (40%) of American teens say that they have been in cars when the drivers used cell phones in a way that endangered their lives. Distractions from a cell phone include texting; sending or receiving emails; surfing the web; taking a photo; using Facebook, Twitter and Instagram; answering or making a call; using the map function; and changing songs, for example. In June 2011, more than 196 billion text messages were sent and received in the US, which was a 50% rise from the previous year. Sending or receiving a text takes a driver's eyes from the road for an average of 4.6 seconds, the equivalent-at 55 mph-of driving the length of an entire football field, blind. Furthermore, driving while using a cell phone reduces the amount of brain activity associated with driving by 37%.

Efforts to curtail cell phone usage while driving have, in general, focused on law enforcement solutions. However, law enforcement solutions often fail at curtailing cell phone usage because they are not capable of directly limiting the functionality of a cell phone or other portable electronic device while in transit.

Efforts to curtail the usage of cell phones and other portable electronic devices through software also have been attempted. However, these software solutions often rely on overly complicated methods of implementation.

### BRIEF DESCRIPTION OF THE DRAWINGS

FIG. 1 illustrates an example TextLimit system according to implementations of the present disclosure

### DETAILED DESCRIPTION

Implementations of the present invention provide systems and methods that may reduce distracted driving by limiting in a unique way a portable electronic device based on the location of the portable electronic device or the speed of the portable electronic device.

Furthermore, implementations of the present disclosure allow an administrator of a portable electronic device (e.g., a parent, employer) through a web application to register a portable electronic device and then set a minimum speed at which the portable device becomes limited (for example, limiting calling and/or texting). In some implementations, the administrator also can set locations or geographical areas where and dates and times when the portable electronic device will be limited (“TextLimit Zones”). In some implementations, the administrator can set a maximum speed at which the administrator (or another designated recipient) will receive an alert message when the portable electronic device exceeds that speed. In some implementations, the administrator can specify one or more telephone numbers (“Go Through Numbers”) that the portable electronic device can still communicate with when the portable electronic device is limited due to the settings established by the administrator.

To limit a portable electronic device based on the settings of an administrator, in some implementations, a mobile application (hereinafter, “TextLimit App”) is downloaded onto the portable electronic device. In some implementations, a mobile operation system specific TextLimit App may be provided for different mobile operating systems such as, but not limited to, Android from Google Inc., iOS from Apple Inc., a BlackBerry mobile OS from BlackBerry, and Windows Phone from Microsoft.

In some implementations, the TextLimit App may interface with a TextLimit web server to control the portable electronic device based on the settings of an administrator, which may be stored on a database. In some implementations, through the TextLimit App, a constant connection can be maintained between the TextLimit server and the portable electronic device to control the portable electronic device based on the settings of an administrator.

In some implementations, the TextLimit App on a portable electronic device in conjunction with the TextLimit server can block calls and text messages to/from the portable electronic device and prevent web browsing on the portable electronic device when the portable electronic device is within a TextLimit Zone set by the administrator. In some implementations, the TextLimit App on a portable electronic device in conjunction with the TextLimit server can block calls and text messages to/from the portable electronic device and prevent web browsing on the portable electronic device when the portable electronic device exceeds a speed set by the administrator. In some implementations, the TextLimit App on the portable electronic device in conjunction with the TextLimit server can block calls and text messages as discussed above yet still permit calls and text messages to and from one or more Go Through Numbers set by the administrator. In some implementations, the TextLimit App on the portable electronic device in conjunction with the TextLimit server may cause an alert message (e.g., a text or email) to be sent to a recipient designated by the administrator when the portable electronic device exceeds a maximum speed set by the administrator.

In some implementations, the TextLimit App on a portable electronic device in conjunction with the TextLimit server can offer other services. For example, a log of the current and past locations of the portable electronic device can be maintained and displayed to the administrator through a web application.

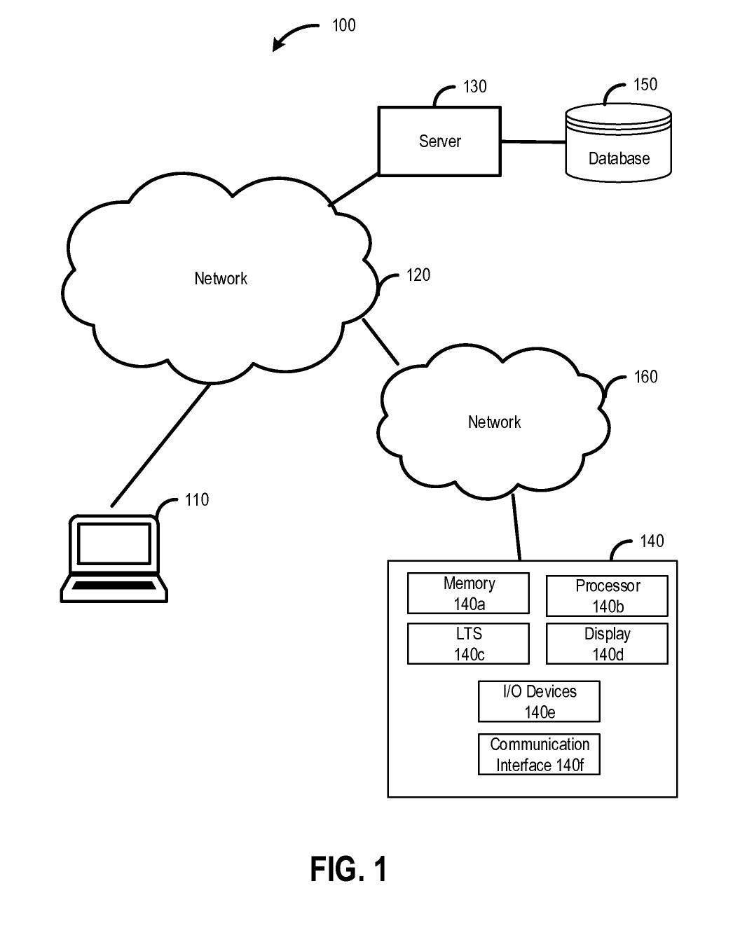

FIG. 1 illustrates an example TextLimit system 100 according to implementations of the present disclosure. In some implementations, an administrator via a computer 110 can connect via a network 120 to the TextLimit web server 130 to register and set limitations for a portable electronic device 140 such as a smartphone as discussed above. In some implementations, an administrator via a portable electronic device 140a can connect via a network 160 to the TextLimit web server 130 to register and set limitations for a portable electronic device 140 such as a smartphone as discussed above

In some implementations, an administrator can interact with the TextLimit web server 130 via an application, such as a web browser or a native application, residing on a computer 140 or portable electronic device 140a. In some implementations, limitation settings (e.g., minimum speed, TextLimit Zone, maximum speed, Go Through Numbers, notification recipients) designated by an administrator for a portable electronic device 140 can be stored in a database 150.

In some implementations, when the portable electronic device 140 downloads the TextLimit App (e.g., from an app store), the TextLimit App interfaces with the TextLimit server 130 via a network (e.g., network 160) to control (as discussed generally above and in detail below) the portable electronic device 140 based on the settings of the administrator which are stored in the database 150. In some implementations, the TextLimit App and/or any related, required, or useful applications, plug-ins, readers, viewers, updates, patches, or other code for executing TextLimit App may be downloaded via a network or installed on a portable electronic device 140 in any other known manner.

In some implementations, networks 120, 160 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/ or messages (generally referred to as data) via any one or more wired and/or wireless communication links. In some implementations, the network(s) may include any communication link known to persons of skill, including for example, cloud, cellular or satellite transmission, magnetic or optical media, radio frequency transmission, microwave or fiber optic transmission, or communications via Internet, cable, or satellite providers.

In some implementations, a portable electronic device 140 may be any type of portable or mobile electronic device, such as for example, a smartphone, a cell phone, a mobile telephone, personal digital assistant (PDA), laptop computer, tablet-style computer, or any other device that a user may hold in his or her hand. For example, in some implementations, the portable electronic device 140 may be a smart phone, such as an iPhone by Apple Inc., a Blackberry phone by RIM, or a phone using an Android operating system (OS), for example.

As shown in FIG. 1, in some implementations, a portable electronic device 140 may include a memory 140a, processor 140b, location tracking system 140c, a display 140d, input/output devices 140e, and a communication interface 140f.

In some implementations, the memory 140a may store the TextLimit App and other data (e.g., location data, configuration settings of the device, and any other data required for the TextLimit App to run, etc.). In some implementations, the memory 140a may comprise any one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, a rewritable optical disk, a rewritable magnetic tape, and/or any other type of volatile or non-volatile memory or storage device. In some implementations, the TextLimit App may be embodied in any combination of software, firmware, and/or any other type of computer-readable instructions.

In some implementations, the processor 140b may include a microprocessor, a microcontroller, a digital signal processor (DSP), an application specific integrated controller (ASIC), electrically-programmable read-only memory (EPROM), or a field-programmable gate array (FPGA), or any other suitable processor(s), and may be generally operable to execute instructions for the TextLimit App, as well as providing any other functions of the portable electronic device 140. In some implementations, the processor 140b can be a number of processors, a multi-processor core, or some other type of processor, depending on the particular implementation. In some implementations, the processor 140b can be implemented using a number of heterogeneous processor systems in which a main processor is present with secondary processors on a single chip.

In some implementations, the portable electronic device 140 may include a location tracking system 140c for tracking the geographic location of the portable electronic device 140. In some implementations, the location tracking system (LTC) 140c can include a global positioning system (“GPS”) receiver for accessing a GPS application function that returns the geographic coordinates (i.e., the geographic location) of the portable electronic device 140. In some implementations, the positioning system can utilize any suitable trilateration or triangulation technique to determine the geographic coordinates of the portable electronic device 140. In some implementations, the location tracking system 140c can determine various measurements (e.g., signal-to-noise ratio (“SNR”) or signal strength measurements) of a network signal (e.g., a cellular telephone network signal, a wireless network access point or “hot spot,” or any other suitable network signal) associated with the portable electronic device 140 to determine its location.

In some implementations, the display 140d may comprise an LCD screen (e.g., thin film transistor (TFT) LCD or super twisted nematic (STN) LCD), an organic light-emitting diode (OLED) display, or any other suitable type of display. In some implementations, the display 140d may be an interactive display (e.g., a touch screen).

In some implementations, the input/output devices 140e may include any suitable interfaces allowing a user to interact with the portable electronic device 140. In some implementations, the input/output devices 140e may include a touch screen, physical buttons, sliders, switches, data ports, keyboard, mouse, voice activated interfaces, or any other suitable devices.

In some implementations, the communication interface 140f can be any interface that enables communication between the portable electronic device 140 and external devices, machines and/ or elements such as web server 130 or an app store. In some implementations, the communication interface 140f may include, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, or any other such interfaces for connecting the portable electronic device 140 to other computing devices and/or communication networks such as the Internet. Such connections can include a wired connection or a wireless connection (e.g. 802.11) though it should be understood that communication interface 140f can be practically any interface that enables communication to/from the portable electronic device 140.

In some implementations, once the TextLimit App is downloaded to the portable electronic device 140 and launched for initial set up, no additional start/stop activities by the user may be required. In some implementations, when the TextLimit App connects to the TextLimit web server 130, the TextLimit App may run in the background. In some implementations, the TextLimit App may collect data using the location tracking system in the portable electronic device to determine location and speed and further process such data as discussed generally above and in detail below to limit the functionality of the portable electronic device 140.

Alternatively, in some implementations, the TextLimit web server 130 may receive location data from the portable electronic device 140 and further process such data as discussed generally above and in detail below to limit the functionality of the portable electronic device. In some implementations, the TextLimit web server 130 may be configured to perform some or all of the data processing discussed above and below. In some implementations, the portable electronic device 140 may communicate some or all data collected by the portable electronic device 140 to the TextLimit web server 130, which may process the received data. In some implementations, after processing the data, the TextLimit web server 130 may limit the portable electronic device 140 as described generally above and in detail below.

In some implementations, the communication of data, data processing, and control functionality may be performed in real time or non-real time. For example, in some implementations, the portable electronic device may receive information from the server (or vice-versa) at a constant time interval, for example, every 5 minutes. In some implementations, the constant time interval may be shorter or longer than 5 minutes. In some implementations, the time interval is not constant.

In some implementations, an administrator registers a portable electronic device 140 on the TextLimit web server 130 and then the TextLimit App is downloaded to the portable electronic device 140. In some implementations, the administrator may set personal setting(s) and device setting(s) though a web application stored on the web server 130. In some implementations, as discussed above, the Administrator may set a minimum speed, TextLimit Zone, maximum speed, Go Through Numbers, and notification recipients for the portable electronic device.

In some implementations, once the operation system-specific (e.g., Android, Blackberry, and iOS) TextLimit App is downloaded to the portable electronic device 140 and administrative privileges have been given, the TextLimit App may monitor the speed and/or location of the portable electronic device 140 and perform other functionalities to control and monitor the portable electronic device as discussed below.

In some implementations, the TextLimit App may pull at regular intervals from the database 150 the minimum and maximum speeds set by the administrator and compare it to the speed of the portable electronic device 140. In some implementations, the TextLimit App may determine the speed of the portable electronic device 140 based on two successive location changes from the location tracking system 140c.

In some implementations, the TextLimit App may receive the speed of the automobile in which the portable electronic device 140 is traveling via Bluetooth directly from the automobile telemetry. In some implementations, the TextLimit App also may pull at regular intervals from the server 130 and/or database 150 the TextLimit Zone(s) set by the administrator and compare it to the location of the portable electronic device 140.

In some implementations, if the speed of the portable electronic device 140 exceeds the maximum speed set by the administrator, then the TextLimit App or TextLimit server 130 can send a text message and/or email to a designated recipient set by the administrator. In some implementations, the web application sends a text massage or email to a designated recipient set by the administrator and stored in the server 130 and/or database 150 after receiving an application programming interface (API) Call from the portable electronic device 140.

In some implementations, the TextLimit App can transmit the location readings of a portable electronic device 140 to the TextLimit web server 130 so that the administrator, through the web application, can monitor the portable electronic device. In some implementations, if the TextLimit web server 130 does not receive notifications from the TextLimit App, an alert message can be sent to a designated recipient set by the administrator.

For Android and Blackberry operating systems, in some implementations, if the speed of the portable electronic device 140 exceeds the minimum speed set by the administrator or the portable electronic device 140 is in a TextLimit Zone, the TextLimit App broadcast receiver may monitor the call activity broadcasted. In some implementations, if the calling number is on the Go Through Numbers list, the call is allowed through; if the call is not on the Go Through Numbers list, then, in some implementations, the call is sent to voicemail. In some implementations, if the speed of the portable electronic device 140 exceeds the minimum speed set by the administrator or the portable electronic device 140 is in a TextLimit Zone, the screen on the portable electronic device 140 may be blacked out and the touch display 140d may be disabled. In some implementations, when a call is not on the Go Through Numbers list, then, the display 140d remains blacked out and the touch screen remains disabled thereby preventing the user from viewing and answering the incoming call; if the call is on the Go Through Numbers list, then the display 140d and touch screen operate as usual and the user is allowed to view and answer the call.

For Android and Blackberry operating systems, in some implementations, to limit text messages once the speed of the portable electronic device 140 exceeds the minimum speed set by the administrator or the portable electronic device 140 is in a TextLimit Zone, the screen on the portable electronic device is blacked out and the display 140d is disabled. It is noted that text messages are still received as normal by the portable electronic device 140, however, because the display 104d is blacked out, the user is prevented from texting (including reading or creating text messages) and browsing. In some implementations, because display 140d is blacked out and the touch screen is disabled the user cannot use any other features of the phone (e.g., the user cannot initiate a call or web browse).

For iOS operating systems, in some implementations, if the speed of the portable electronic device 140 exceeds the minimum speed set by the administrator or the portable electronic device 140 is in a TextLimit Zone, the TextLimit App will constantly and repeatedly trigger the phone notification and an alert box (which, in some implementations, may be configured by the user) will continuously be the active box on the display 140d of the portable electronic device 140. Thus, when there is an incoming call, the user cannot answer the phone because the alert box will be the active box on the display 140d of the portable electronic device 140. In some implementations, if the calling number is on the Go Through Numbers list, the call is allowed through by momentarily ceasing the triggering of the phone notification.

For iOS operating systems, in some implementations, to limit text messages once the speed of the portable electronic device 140 exceeds the minimum speed set by the administrator or the portable electronic device 140 is in a TextLimit Zone, the TextLimit App will constantly and repeatedly trigger the phone notification and an alert box will continuously be the active box on the display 140d of the portable electronic device 140. Because the alert box is the active box, the user is prevented from texting (including reading or creating text messages) and browsing. It is noted that all of the functions of the portable electronic device 140 also are limited due to the alert box obscuring the display 140d. In some implementations, when the alert box is active, the user may press a “Settings” button in the alert box to go to a TextLimit App screen where the user may make an emergency phone call no matter the condition of the phone (e.g., above the minimum speed or in an active TextLimit Zone).

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

In some implementations, for example, using a machine or tangible computer-readable medium or article which may store an instruction or a set of instructions that, if executed by a machine, may cause the machine to perform a method and/or operations in accordance with the implementations. Such a machine may include, for example, any suitable processing platform, computing platform, computing device, processing device, computing system, processing system, computer, processor, or the like, and may be implemented using any suitable combination of hardware and/or software. In some implementations, the machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. In some implementations, the instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The implementations are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the implementations of the present invention can be implemented in a variety of forms. Therefore, while the implementations of this invention have been described in connection with particular examples thereof, the true scope of the implementations of the invention should not be so limited since other modifications will become apparent to the skilled practitioner upon a study of this disclosure.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

1. A computer-implemented method for limiting the functionality of a portable electronic device, the method comprising:
monitoring the speed of the portable electronic device;
receiving a minimum speed value set by an administrator; and
disabling the display of the portable electronic device based on the speed of the portable electronic device and the minimum speed value.

2. The computer-implemented method of claim 1 further comprising the step of disabling notification systems of the portable electronic device configured to alert a user of an incoming call based on the speed of the portable electronic device and the minimum speed value.

3. The method of claim 2 further comprising the steps of receiving a list of go through numbers and at least temporarily activating the display and notification systems of the portable electronic device based on the list of go through numbers received.

4. The computer-implemented method of claim 1 wherein disabling the display of the portable electronic device based on the speed of the portable electronic device and the minimum speed value comprises causing an alert box to at least partially obscure the display of the portable electronic device.

5. The method of claim 1 further comprising the steps of receiving a maximum speed value set by an administrator and sending an alert message to a designated recipient based on the speed of the portable electronic device and the maximum speed value.

6. The method of claim 1 further comprising the step of transmitting the geographic location of the portable electronic device.

7. The method of claim 6 further comprising the steps of receiving a list of geographical areas and disabling the display of the portable electronic device based on the geographic location of the portable electronic device and the list of geographical areas received.

8. The method of claim 7 wherein disabling the display of the portable electronic device comprises causing an alert box to at least partially obscure the display of the portable electronic device.

9. The computer-implemented method of claim 1 further comprising the step of disabling notification systems of the portable electronic device configured to alert a user of an incoming text message based on the speed of the portable electronic device and the minimum speed value.

10. The method of claim 9 further comprising the steps of receiving a list of go through numbers and at least temporarily activating the display and notification systems of the portable electronic device based on the list of go through numbers received.

11. A non-transitory computer readable medium containing instructions that, when executed by a processor on a portable electronic device, cause the portable electronic device to:
monitor the speed of the portable electronic device;
receive a minimum speed value set by an administrator; and
disable the display of the portable electronic device based on the speed of the portable electronic device and the minimum speed value.

12. The non-transitory computer readable medium of claim 11 comprising further instructions to disable notification systems of the portable electronic device configured to alert a user of an incoming call based on the speed of the portable electronic device and the minimum speed value.

13. The non-transitory computer readable medium of claim 12 comprising further instructions to receive a list of go through numbers and to at least temporarily activate the display and notification systems of the portable electronic device based on the list of go through numbers received

14. The non-transitory computer readable medium of claim 11 comprising further instructions to disable the display of the portable electronic device based on the speed of the portable electronic device and the minimum speed value received by causing an alert box to at least partially obscure the display of the portable electronic device

15. The non-transitory computer readable medium of claim 11 comprising further instructions to receive a maximum speed value set by an administrator and to send an alert message to a designated recipient based on the speed of the portable electronic device and the maximum speed value.

16. The non-transitory computer readable medium of claim 11 comprising further instructions to transmit the geographic location of the portable electronic device.

17. The non-transitory computer readable medium of claim 16 comprising further instructions to receive a list of geographical areas and to disable the display of the portable electronic device based on the geographic location of the portable electronic device and the list of geographical areas received.

18. The non-transitory computer readable medium of claim 17 comprising further instructions to disable the display of the portable electronic device by causing an alert box to at least partially obscure the display of the portable electronic device.

19. The non-transitory computer readable medium of claim 11 comprising further instructions to disable notification systems of the portable electronic device configured to alert a user of an incoming text message based on the speed of the portable electronic device and the minimum speed value.

20. The non-transitory computer readable medium of claim 11 comprising further instructions to receive a list of go through numbers and to at least temporarily activate the display and notification systems of the portable electronic device based on the list of go through numbers received.

21. A computer server-implemented method for limiting the functionality of a portable electronic device, the method comprising:
receiving and storing a maximum and minimum speed value set by an administrator;
monitoring the speed of the portable electronic device;
receiving the geographic location of the portable electronic device;
disabling the display of the portable electronic device based on the speed of the portable electronic device and the minimum speed value or geographic location of the portable electronic device; and
sending an alert message to designated recipient based on the speed of the portable electronic device and the maximum speed value

22. The method of claim 21 further comprising the steps of sending an alert message to a designated recipient based on receiving the geographic location of the portable electronic device.
